(19) United States
(12) Patent Application Publication
(10) Pub. No.: US 2025/0276597 A1
(43) Pub. Date: Sep. 4, 2025

(54) ELECTRIC VEHICLE CHARGING SYSTEM

(71) Applicants: Hyundai Motor Company, Seoul (KR); Kia Corporation, Seoul (KR)

(72) Inventors: Ji Hee Ham, Suwon-si (KR); Won Keun Kim, Seoul (KR); Jong Chan Song, Suwon-si (KR); Jae Wook Shin, Siheung-si (KR); Seong Min Ha, Seoul (KR); Seung Jong Lee, Seoul (KR); Kyoung Han Ryu, Yongin-si (KR); A Reum Ha, Ulsan (KR)

(21) Appl. No.: 18/758,718

(22) Filed: Jun. 28, 2024

(30) Foreign Application Priority Data
Feb. 29, 2024 (KR) 10-2024-0030139

(51) Int. Cl. B60L 53/62; B60L 53/12; B60L 53/53; B60L 53/67

(52) U.S. Cl. CPC B60L 53/62; B60L 53/12; B60L 53/53; B60L 53/67

(57) ABSTRACT

An embodiment electric vehicle charging system includes an energy storage bank configured to selectively store electric power supplied to an electric power customer, an electric vehicle charger configured to charge an electric vehicle with the electric power supplied to the electric power customer or with energy stored in the energy storage bank, and a controller configured to determine, based on meter data of an electric power meter measuring the electric power supplied to the electric power customer and an electric power reference level based on a maximum level of electric power supplied to the electric power customer, whether to store the electric power supplied to the electric power customer in the energy storage bank.

### CROSS-REFERENCE TO RELATED APPLICATIONS

This application claims the benefit of Korean Patent Application No. 10-2024-0030139, filed on Feb. 29, 2024, which application is hereby incorporated herein by reference in its entirety.

### TECHNICAL FIELD

The present disclosure relates to an electric vehicle charging system.

### BACKGROUND

Recently, with an increase in supply of electric vehicles, the number of chargers charging electric vehicles has also been increasing. As a result, total electric power used by multiple chargers has been also increasing, and a proportion of total electric power used by multiple chargers among total electric power supplied by an electric power system has been also increasing. Accordingly, electric power use stability (for example, prevention of electric power outages) of an electric power customer also has been becoming increasingly important.

### SUMMARY

Embodiments of the present disclosure provide an electric vehicle charging system.

According to an embodiment of the present disclosure, there is provided an electric vehicle charging system including an energy storage bank configured to selectively store at least a portion of electric power supplied to an electric power customer, an electric vehicle charger configured to charge an electric vehicle with at least a portion of the electric power supplied to the electric power customer or energy stored in the energy storage bank, and a controller configured to determine, based on meter data of an electric power meter measuring the electric power supplied to the electric power customer and an electric power reference level based on a maximum level of electric power supplied to the electric power customer, whether to store, in the energy storage bank, at least a portion of the electric power supplied to the electric power customer.

According to another embodiment of the present disclosure, there is provided an electric vehicle charging system including an energy storage bank configured to selectively store at least a portion of electric power supplied to an electric power customer, an electric vehicle charger configured to charge an electric vehicle with at least a portion of the electric power supplied to the electric power customer or energy stored in the energy storage bank, and a controller configured to determine, based on meter data of an electric power meter measuring the electric power supplied to the electric power customer and an electric power reference level based on a maximum level of electric power supplied to the electric power customer, whether to supply the energy in the energy storage bank when the electric vehicle charger charges the electric vehicle.

### BRIEF DESCRIPTION OF THE DRAWINGS

The above and other aspects, features, and advantages of embodiments of the present disclosure will be more clearly understood from the following detailed description, taken in conjunction with the accompanying drawings, in which:

FIGS. 1 to 3 are diagrams of an electric vehicle charging system according to an example embodiment of the present disclosure; and

FIGS. 4 to 6 are flowcharts of sequential operations of an electric vehicle charging system according to an example embodiment of the present disclosure.

### DETAILED DESCRIPTION OF ILLUSTRATIVE EMBODIMENTS

Various modifications may be made to the example embodiments. Here, the example embodiments should not be construed as being limited to the present disclosure and should be understood to include all changes, equivalents, and replacements within the idea and the technical scope of the disclosure.

The terms such as first, second, A, B, (a), (b), and the like may be used herein to describe components. Each of these terminologies is not used to define an essence, order, or sequence of a corresponding component but is used merely to distinguish the corresponding component from other component(s). For example, a first component may be referred to as a second component, and similarly the second component may also be referred to as the first component. The term “and/or” may include combinations of a plurality of related described items or any of a plurality of related described items.

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, steps, operations, elements, components, or a combination thereof, but they do not preclude the presence or addition of one or more other features, integers, steps, operations, elements, components, and/or groups thereof.

Unless otherwise defined herein, all terms used herein, including technical or scientific terms, have the same meanings as those generally understood by one of ordinary skill in the art. Terms defined in dictionaries generally used should be construed to have meanings matching contextual meanings in the related art and are not to be construed as having an ideal or excessively formal meaning, unless otherwise defined herein.

As used herein, a vehicle (including an electric vehicle) refers to various vehicles transporting a transported object such as a person, an animal, or an object from a starting point to a destination. Such vehicles are not limited to vehicles travelling on roads or tracks.

Hereinafter, preferred example embodiments of the present disclosure will be described in more detail with reference to the attached drawings.

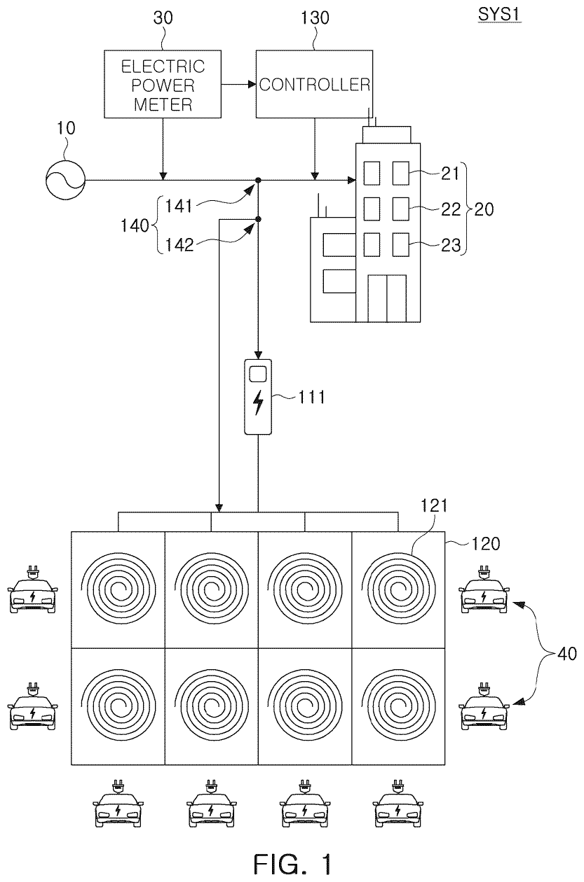

Referring to FIG. 1, an electric power system 10 may supply electric power to an electric power customer 20. For example, the electric power system 10 may include a substation, a transformer, and a distribution line, and it may supply commercial power (for example, 220V and 60 Hz) to the electric power customer 20 through the distribution line. For example, the electric power customer 20 may include a plurality of electric power users 21, 22, and 23, and supplied electric power may be sub-distributed from power supplied to the electric power customer 20, and the sub-distributed electric power may be supplied to the plurality of electric power users 21, 22, and 23. For example, the electric power customer 20 may be an apartment complex, and the plurality of electric power users 21, 22, and 23 may be a plurality of apartments or a plurality of residential units within the apartment complex, but the present disclosure is not limited thereto. For example, the electric power customer 20 may be a school, a large shopping mall, or a large building in which a maximum level of supplied electric power is set.

Referring to FIG. 1, an electric vehicle charging system SYS1 according to an example embodiment of the present disclosure may include an energy storage bank 111, an electric vehicle charger 120, and a controller 130.

The energy storage bank 111 may be configured to selectively store at least a portion of the electric power supplied from the electric power system 10 to the electric power customer 20. For example, the energy storage bank 111 may include a plurality of batteries, an AC-DC converter, and a DC-AC inverter. The AC-DC converter may convert AC electric power supplied from the electric power system 10 into DC energy, and it may charge the plurality of batteries with the DC energy, and the DC-AC inverter may convert the DC energy stored in the plurality of batteries into AC energy, and it may discharge the plurality of batteries.

The electric vehicle charger 120 may be configured to charge an electric vehicle 40 with at least a portion of the electric power supplied to the electric power customer 20 or energy stored in the energy storage bank 111. While the electric vehicle charger 120 charges the electric vehicle 40 with at least a portion of the electric power supplied to the electric power customer 20, a total amount of electric power, usable by the electric power customer 20, may temporarily decrease. In this case, when a large real-time amount of electric power is used by the electric power customer 20, the electric power customer 20 and/or the electric vehicle charger 120 may have temporarily decreased electric power use stability and convenience. In this case, the electric vehicle charger 120 may charge the electric vehicle 40 with the energy stored in the energy storage bank 111, thereby preventing a decrease in the electric power use stability and convenience of the electric power customer 20 and/or the electric vehicle charger 120.

However, a timing, frequency, and load at which the electric vehicle charger 120 charges the electric vehicle 40 may not be easily predicted or may be variable, and an electric power usage pattern and properties of the electric power customer 20 may also not be easily predicted or may be variable.

The controller 130 may be configured to determine, based on meter data of an electric power meter 30 measuring the electric power supplied to the electric power customer 20 and an electric power reference level based on a maximum level of electric power supplied to the electric power customer 20, whether to store, in the energy storage bank 111, at least a portion of the electric power supplied to the electric power customer 20.

When the electric power customer 20 uses a small amount of electric power, the controller 130 may control a portion of the electric power supplied to the electric power customer 20 to be charged to the energy storage bank 111. When the electric power customer 20 uses a large amount of electric power, the controller 130 may control the electric power supplied to the electric power customer 20 not to be charged to the energy storage bank 111, and the electric vehicle charger 120 may use the energy stored in the energy storage bank 111 to charge the electric vehicle 40, which may be a smart grid of the electric power customer 20. Accordingly, even in a case in which the electric vehicle charger 120 charges the electric vehicle 40 when the electric power customer 20 uses a large amount of electric power, a decrease in electric power use stability and convenience of each of the electric power customer 20 and the electric vehicle 40 may be prevented.

Alternatively, the controller 130 may be configured to determine, based on the meter data of the electric power meter 30 measuring the electric power supplied to the electric power customer and the electric power reference level based on the maximum level of electric power supplied to the electric power customer 20, whether to supply the energy stored in the energy storage bank 111 when the electric vehicle charger 120 charges the electric vehicle 40.

When the electric power customer 20 uses a small amount of electric power, the controller 130 may control a portion of the electric power supplied to the electric power customer 20 to be supplied directly to the electric vehicle charger 120 without passing through the energy storage bank 111, and the electric vehicle charger 120 may use a portion of the electric power supplied to the electric power customer 20 to charge the electric vehicle 40 without using the energy stored in the energy storage bank 111. When the electric power customer 20 uses a large amount of electric power, the controller 130 may control the electric power supplied to the electric power customer 20 not to be directly supplied to the electric vehicle charger 120, and the electric vehicle charger 120 may use only the energy stored in the energy storage bank 111 to charge the electric vehicle 40, which may be a smart grid of the electric power customer 20. Accordingly, even in a case in which the electric vehicle charger 120 charges the electric vehicle 40 when the electric power customer 20 uses a large amount of electric power, a decrease in electric power use stability and convenience of each of the electric power customer 20 and the electric vehicle 40 may be prevented.

For example, when the electric power customer 20 is an apartment complex, the electric vehicle charger 120 may intensively charge the electric vehicle 40 immediately after quitting time (for example, evening time). When the energy storage bank 111 intensively stores energy immediately before quitting time (for example, around noon), the electric vehicle charger 120 may most efficiently use the energy of the energy storage bank 111. A smallest number of real-time occupants may be in an apartment complex immediately before quitting time (for example, around noon), such that a smallest amount of electric power may be used in real time in the apartment complex before quitting time (for example, around noon). Accordingly, the controller 130 may store energy in the energy storage bank 111 during times when a small amount of electric power is used in real time in the apartment complex, such that the electric vehicle charger 120 may efficiently use the energy of the energy storage bank 111.

For example, the electric vehicle charger 120 may be a plurality of (for example, eight) electric vehicle chargers 120 charging a plurality of (for example, eight) electric vehicles 40 with the energy stored in the energy storage bank 111. The number of electric vehicle chargers being charged, among the plurality of (for example, eight) the electric vehicle chargers 120, may be determined by a usage pattern of each of the plurality of (for example, eight) electric vehicles 40, such that the number of electric chargers may not be easily predicted or may be variable. A total amount of electric power, usable by a plurality of (for example, eight) electric vehicle chargers 120, may increase as the number of electric vehicle chargers 120 increases, and it may increase as a size of the electric power customer 20 increases. Accordingly, the plurality of (for example, eight) electric vehicle chargers 120 may also have increased electric power use variability. The controller 130 may effectively cope with the electric power use variability. Accordingly, even when there are the plurality of (for example, eight) electric vehicle chargers 120, a decrease in electric power use stability and convenience of each of the electric power customer 20 and the electric vehicle 40 may be prevented.

For example, the plurality of electric vehicle chargers 120 may include a plurality of coils 121 for wireless electric power charging, and the plurality of coils 121 may be arranged (for example, in a 2 by 4 arrangement) in a parking lot of the electric power customer 20. Accordingly, even when there are the plurality of electric vehicle chargers 120, the electric power customer 20 may provide the plurality of electric vehicle chargers 120 to the plurality of electric vehicles 40. This may be because a wireless electric power charging method is relatively free from space/time constraints.

For example, the plurality of coils 121 of the plurality of electric vehicle chargers 120 may be connected to a single energy storage bank 111 through a plurality of wires, and the plurality of electric vehicle chargers 120 may receive DC energy from the energy storage bank 111 to charge the plurality of parked electric vehicles 40 through a circuit (for example, a converter or resonance circuit) for wireless electric power charging (for example, magnetic induction-type wireless charging or magnetic resonance-type wireless charging). For example, the plurality of coils 121 and the plurality of wires of the plurality of electric vehicle chargers 120 may be buried in the ground of the parking lot.

For example, the electric power meter 30 may be installed at the premises of the electric power customer 20 by a company supplying electric power through the electric power system 10. For example, when the energy storage bank 111 and/or the electric vehicle chargers 120 are provided to the electric power customer 20, the controller 130 may be provided together therewith.

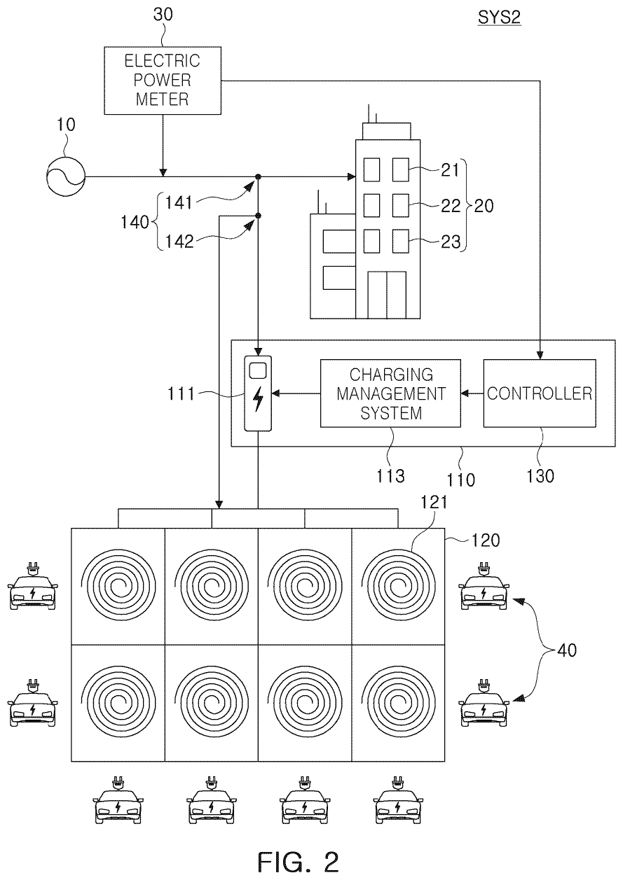

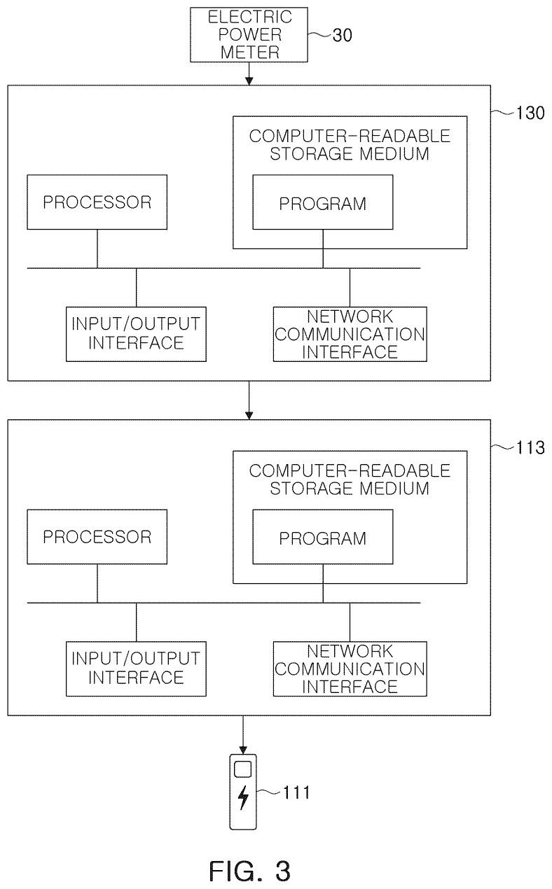

For example, referring to FIG. 2, a controller 130 of an electric vehicle charging system SYS2 according to an example embodiment of the present disclosure may be included in an energy storage system 110. The energy storage system 110 may further include an energy storage bank 111 and a charging management system 113. Referring to FIG. 3, each of the charging management system 113 and the controller 130 may be implemented as a computing system (for example, a computer, a server, or electronic equipment), and the computing system may include a processor, a computer-readable storage medium (for example, volatile memory, non-volatile memory, or data storage), an input/output interface, and a network communication interface. Depending on a design thereof, the charging management system 113 and the controller 130 may be integrated into a single computing system.

For example, the charging management system 113 may calculate the number of batteries to charge an energy storage bank 111 with electric power, may calculate an amount of electric power consumption required when electric power supply is requested from an electric vehicle charger 120, may calculate, based on a state of charge (SoC) of the current energy storage bank 111, an amount of available electric power, may calculate a time at which the current energy storage bank 111 is capable of supplying electric power, may statistically process an electric power supply history of the current energy storage bank 111, may detect that an electric vehicle 40 enters a parking lot, may detect that the electric vehicle 40 is parked on a coil, may calculate a period of time required for the electric vehicle charger 120 to charge the electric vehicle 40 and a charging speed of the electric vehicle charger 120 after detection, may control the charging speed, and may control stopping of electric power consumption upon completion of charging. For example, the charging management system 113 may perform communication (for example, CAN communication) with the energy storage bank 111, the electric vehicle charger 120, and an electric power meter 30. For example, the communication may be implemented through Ethernet, media-oriented systems transport (MOST), Flexray, controller area network (CAN), local interconnect network (LIN), Internet, LTE, 5G, Wi-Fi, Bluetooth®, near field communication (NFC), Zigbee®, radio frequency (RF), or the like.

The controller 130 may determine, according to a ratio of a level of supplied electric power of meter data of the electric power meter 30 and a maximum level of electric power supplied to the electric power customer 20, whether to store, in the energy storage bank 111, at least a portion of electric power supplied to the electric power customer 20, or whether to supply energy stored in the energy storage bank 111 when the electric vehicle charger 120 charges the electric vehicle 40. For example, the maximum level of electric power supplied to the electric power customer may be determined by a company supplying electric power through the electric power system 10, and it may be a fixed value that is not arbitrarily changeable by the electric power customer 20. Accordingly, the controller 130 may define the maximum level of electric power supplied to the electric power customer as a constant to calculate the ratio. Accordingly, the control of the controller 130 may be a smart grid in units of a single electric power customer 20.

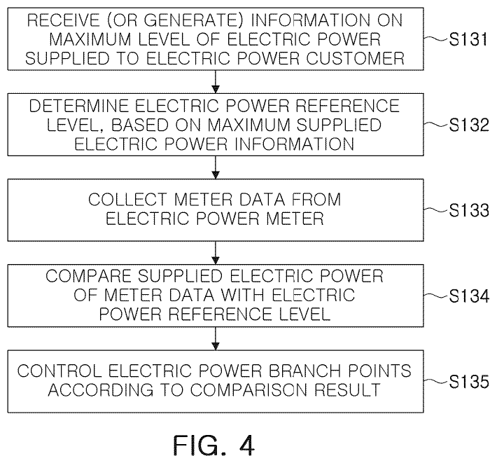

Referring to FIGS. 1 and 4, a controller 130 of an electric vehicle charging system according to an example embodiment of the present disclosure may perform an operation (S131) of receiving (or generating) information on a maximum level of electric power supplied to an electric power customer 20, may perform an operation (S132) of determining an electric power reference level, based on the maximum level of electric power supplied to the electric power customer information, may perform an operation (S133) of collecting meter data from an electric power meter 30, may perform an operation (S134) of comparing a level of supplied electric power of the meter data with the reference level of electric power, and may perform an operation (S135) of controlling electric power branch points 140 (e.g., electric power branch points 141 and 142) according to a comparison result.

For example, the maximum level of electric power supplied to the electric power customer information and/or the electric power reference level may be remotely received from a system (for example, an advanced metering infrastructure system) of a company supplying electric power through the electric power system 10, may be part of initial information stored in the controller 130, or may be information input to the controller 130 by a user (for example, an apartment manager or an energy storage system manager). For example, the electric power branch points 141 and 142 may be implemented as circuits controlling a plurality of switches (or relays or breakers), and the controller 130 may transmit a control signal to the circuits.

For example, the electric power reference level may include a first electric power reference level and a second electric power reference level. The controller 130 may determine, based on the meter data of the electric power meter 30 and the second electric power reference level, whether to supply energy stored in an energy storage bank 111 when an electric vehicle charger 120 charges an electric vehicle 40, and may determine, based on the meter data of the electric power meter 30 and the first electric power reference level, whether to store, in the energy storage bank 111, at least a portion of electric power supplied to the electric power customer 20. Alternatively, the controller 130 may store, in the energy storage bank 111, at least a portion of the electric power supplied to the electric power customer 20 when a state in which a level of supplied electric power of the meter data of the electric power meter 30 is higher than the first electric power reference level is changed to a state in which the level of supplied electric power of the meter data of the electric power meter 30 is lower than the first electric power reference level, and may control the electric vehicle charger 120 to receive the energy stored in the energy storage bank 111 when the electric vehicle charger 120 charges the electric vehicle 40 in a case in which the level of supplied electric power of the meter data of the electric power meter 30 is higher than the second electric power reference level.

For example, the second electric power reference level may be higher than the first electric power reference level, thereby preventing an overall SoC of the energy storage bank 111 from being maintained to be excessively low, preventing malfunctions caused by operational confusion of the energy storage bank 111, and improving operational stability and a lifespan of the energy storage bank 111.

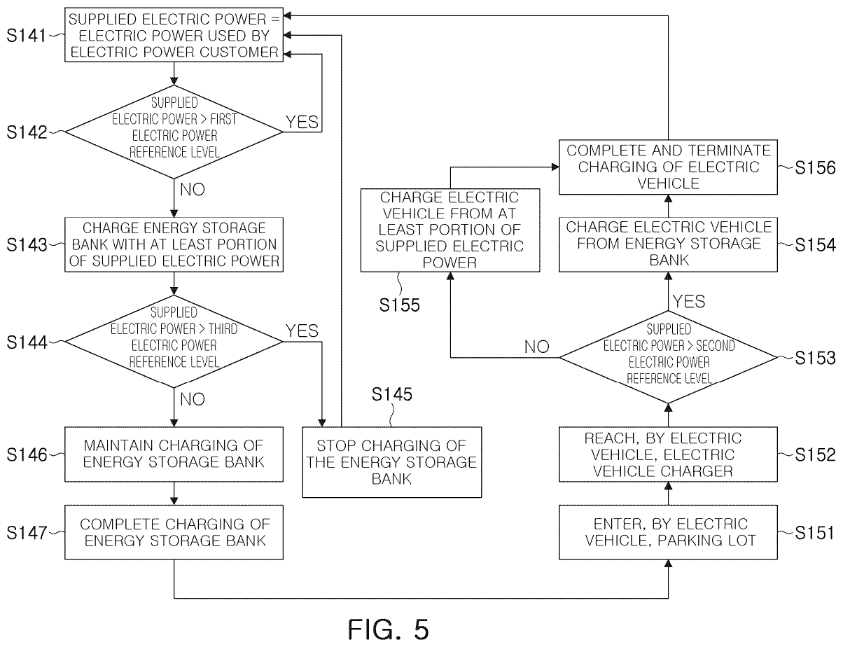

Referring to FIGS. 1 and 5, in a state in which a level of supplied electric power is the same as a level of electric power used by an electric power customer (S141), an electric vehicle charging system according to an example embodiment of the present disclosure may perform a comparison operation (S142) for identifying whether the level of supplied electric power is higher than a first electric power reference level, may perform an operation (S143) of charging an energy storage bank 111 with at least a portion of the supplied electric power when a state in which the level of supplied electric power is higher than a first electric power reference level is changed to a state in which the level of supplied electric power is not higher than the first electric power reference level, may perform a comparison operation (S144) for identifying whether the level of supplied electric power is higher than a third electric power reference level, may perform an operation (S145) of stopping charging of the energy storage bank 111 when the level of supplied electric power is higher than the third electric power reference level, may perform an operation (S146) of maintaining charging of the energy storage bank 111 when the level of supplied electric power is not higher than the third electric power reference level, and may complete charging of the energy storage bank 111 (S147). In a state in which an electric vehicle 40 enters a parking lot (S151) and reaches an electric vehicle charger 120 (S152), the electric vehicle charging system according to an example embodiment of the present disclosure may perform a comparison operation (S153) for identifying whether the level of supplied electric power is higher than a second electric power reference level, may perform an operation (S154) of charging the electric vehicle 40 from the energy storage bank 111 when the level of supplied electric power is higher than the second electric power reference level, may perform an operation (S155) of charging the electric vehicle 40 from at least a portion of the supplied electric power when the level of supplied electric power is not higher than the second electric power reference level, and may complete and terminate charging of the electric vehicle 40 (S156).

An electric power reference level may include at least one of a first electric power reference level, a second electric power reference level, and a third electric power reference level. A controller 130 may store, in the energy storage bank 111, at least a portion of electric power supplied to an electric power customer 20 when a state in which a level of supplied electric power of meter data of an electric power meter 30 is higher than the first electric power reference level is changed to a state in which the level of supplied electric power of the meter data of the electric power meter 30 is not higher than the first electric power reference level, may stop an operation of storing, in the energy storage bank 111, at least a portion of the electric power supplied to the electric power customer 20 when a state in which the level of supplied electric power of the meter data is higher than the first electric power reference level is changed to a state in which the level of supplied electric power of the meter data is higher than the third electric power reference level, and may control the electric vehicle charger 120 to receive energy stored in the energy storage bank 111 when the electric vehicle charger 120 charges the electric vehicle 40 in a case in which the level of supplied electric power of the meter data is higher than the second electric power reference level.

For example, the second electric power reference level may be higher than the first electric power reference level and lower than the third electric power reference level, thereby preventing an overall SoC of the energy storage bank 111 from being maintained to be excessively low, preventing malfunctions caused by operational confusion of the energy storage bank 111, and improving operational stability and a lifespan of the energy storage bank 111. For example, the first electric power reference level may be 60% or more and 80% or less (for example, 70%) of the maximum level of electric power supplied to the electric power customer, the second electric power reference level may be 70% or more and 90% or less (for example, 80%) of the maximum level of electric power supplied to the electric power customer, and the third electric power reference level may be 80% or more and 100% or less (for example, 90%) of the maximum level of electric power supplied to the electric power customer.

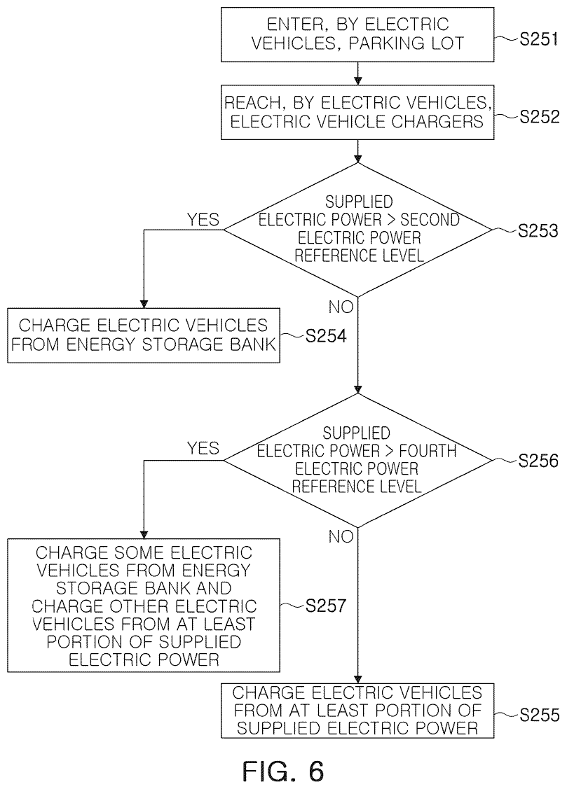

Referring to FIGS. 1 and 6, in a state in which a plurality of electric vehicles 40 enter a parking lot (S251) and reach a plurality of electric vehicle chargers 120 (S252), an electric vehicle charging system according to an example embodiment of the present disclosure may perform a comparison operation (S253) for identifying whether a level of supplied electric power is higher than a second electric power reference level, may perform an operation (S254) of charging all of the plurality of electric vehicles 40 from an energy storage bank 111 when the level of supplied electric power is higher than the second electric power reference level, may perform a comparison operation (S256) for identifying whether the level of supplied electric power is higher than a fourth electric power reference level when the level of supplied electric power is not higher than the second electric power reference level, may perform an operation (S255) of charging all of the plurality of electric vehicles 40 from at least a portion of the supplied electric power when the level of supplied electric power is not higher than the fourth electric power reference level, and may perform an operation (S257) of charging some electric vehicles from the energy storage bank 111 and charging the other electric vehicles from at least a portion of the supplied electric power when the level of supplied electric power is greater than the fourth electric power reference level.

An electric power reference level may further include a fourth electric power reference level, and the fourth electric power reference level may be lower than the second electric power reference level. In a case in which a level of supplied electric power of meter data of an electric power meter 30 is lower than the second electric power reference level and higher than the fourth electric power reference level, a controller 130 may control some electric vehicles, among the plurality of electric vehicles 40, to receive energy stored in the energy storage bank 111 when the some electric vehicles are charged, and may control the other electric vehicles, among the plurality of electric vehicles 40, not to receive the energy stored in the energy storage bank 111 when the other electric vehicles are charged. In a case in which the level of supplied electric power of the meter data is not higher than the fourth reference power, the controller 130 may control the plurality of electric vehicle chargers 120 not to receive the energy stored in the energy storage bank 111 when the plurality of electric vehicle chargers 120 charge the plurality of electric vehicles 40. Accordingly, electric power use stability and convenience of each of the electric power customer 20 and the electric vehicle 40 may be further improved, and an SoC of the energy storage bank 111 may be more stably managed.

As set forth above, according to an example embodiment of the present inventive concept, an electric vehicle charging system may control energy storage and/or electric vehicle charging based on a smart grid for an individual electric power customer. Accordingly, even in a case in which an electric vehicle charger charges an electric vehicle when the electric power customer uses a large amount of power, a decrease in electric power usage stability and convenience of each of the electric power customer and the electric vehicle (for example, prevention of electric power outages) may be prevented.

While example embodiments have been shown and described above, it will be apparent to those skilled in the art that modifications and variations could be made without departing from the scope of the present disclosure as defined by the appended claims.

What is claimed is:

1. An electric vehicle charging system comprising:
an energy storage bank configured to selectively store electric power supplied to an electric power customer;
an electric vehicle charger configured to charge an electric vehicle with the electric power supplied to the electric power customer or with energy stored in the energy storage bank; and
a controller configured to determine, based on meter data of an electric power meter measuring the electric power supplied to the electric power customer and an electric power reference level based on a maximum level of electric power supplied to the electric power customer, whether to store the electric power supplied to the electric power customer in the energy storage bank.

2. The electric vehicle charging system of claim 1, wherein the controller is configured to determine, according to a ratio of a level of supplied electric power of the meter data and the maximum level of electric power supplied to the electric power customer, whether to store the electric power supplied to the electric power customer in the energy storage bank.

3. The electric vehicle charging system of claim 2, wherein the controller is configured to define the maximum level of electric power supplied to the electric power customer as a constant to calculate the ratio.

4. The electric vehicle charging system of claim 1, wherein:
the electric power reference level includes a first electric power reference level; and
the controller is configured to store the electric power supplied to the electric power customer in the energy storage bank in a case in which a state in which a level of supplied electric power of the meter data is higher than the first electric power reference level is changed to a state in which the level of supplied electric power of the meter data is not higher than the first electric power reference level.

5. The electric vehicle charging system of claim 4, wherein:
the electric power reference level further includes a third electric power reference level;
the third electric power reference level is higher than the first electric power reference level; and
the controller is configured to stop an operation of storing the electric power supplied to the electric power customer in the energy storage bank in a case in which a state in which the level of supplied electric power of the meter data is higher than the first electric power reference level is changed to a state in which the level of supplied electric power of the meter data is higher than the third electric power reference level.

6. The electric vehicle charging system of claim 5, wherein:
the electric power reference level further includes a second electric power reference level;
the second electric power reference level is higher than the first electric power reference level and lower than the third electric power reference level; and
the controller is configured to control the electric vehicle charger to receive the energy stored in the energy storage bank in a state in which the electric vehicle charger charges the electric vehicle in a case in which the level of supplied electric power of the meter data is higher than the second electric power reference level.

7. The electric vehicle charging system of claim 6, wherein:
the first electric power reference level is 60% or more and 80% or less of the maximum level of electric power supplied to the electric power customer;
the second electric power reference level is 70% or more and 90% or less of the maximum level of electric power supplied to the electric power customer; and
the third electric power reference level is 80% or more and 100% or less of the maximum level of electric power supplied to the electric power customer.

8. The electric vehicle charging system of claim 6, wherein:
the electric power reference level further includes a fourth electric power reference level;
the fourth electric power reference level is lower than the second electric power reference level;
the electric vehicle charger comprises a plurality of electric vehicle chargers configured to charge a plurality of electric vehicles with the energy stored in the energy storage bank; and
the controller is configured to:
in a case in which the level of supplied electric power of the meter data is lower than the second electric power reference level and higher than the fourth electric power reference level, control a first subset of the plurality of electric vehicles to receive the energy stored in the energy storage bank in a state in which the first subset of the plurality of electric vehicles are charged and control a second subset of the plurality of electric vehicles not to receive the energy stored in the energy storage bank in a state in which the second subset of the plurality of electric vehicles are charged; and
in a case in which the level of supplied electric power of the meter data is lower than the fourth electric power reference level, control the plurality of electric vehicle chargers not to receive the energy stored in the energy storage bank in a state in which the plurality of electric vehicle chargers charge the plurality of electric vehicles.

9. The electric vehicle charging system of claim 1, wherein the electric vehicle charger comprises a plurality of electric vehicle chargers configured to charge a plurality of electric vehicles with the energy stored in the energy storage bank.

10. The electric vehicle charging system of claim 9, wherein:
the plurality of electric vehicle chargers comprises a plurality of coils for wireless electric power charging; and
the plurality of coils is arranged in a parking lot of the electric power customer.

11. The electric vehicle charging system of claim 1, wherein the electric power customer comprises an apartment complex.

12. An electric vehicle charging system comprising:
an energy storage bank configured to selectively store electric power supplied to an electric power customer;
an electric vehicle charger configured to charge an electric vehicle with the electric power supplied to the electric power customer or with energy stored in the energy storage bank; and
a controller configured to determine, based on meter data of an electric power meter measuring the electric power supplied to the electric power customer and an electric power reference level based on a maximum level of electric power supplied to the electric power customer, whether to supply the energy stored in the energy storage bank in a state in which the electric vehicle charger charges the electric vehicle.

13. The electric vehicle charging system of claim 12, wherein the controller is configured to determine, according to a ratio of a level of supplied electric power of the meter data and the maximum level of electric power supplied to the electric power customer, whether to supply the energy stored in the energy storage bank in the state in which the electric vehicle charger charges the electric vehicle.

14. The electric vehicle charging system of claim 13, wherein the controller is configured to define the maximum level of electric power supplied to the electric power customer as a constant to calculate the ratio.

15. The electric vehicle charging system of claim 12, wherein:
the electric power reference level includes a first electric power reference level and a second electric power reference level; and
the controller is configured to:
determine, based on the meter data and the second electric power reference level, whether to supply the energy stored in the energy storage bank in the state in which the electric vehicle charger charges the electric vehicle; and
determine, based on the meter data and the first electric power reference level, whether to store the electric power supplied to the electric power customer in the energy storage bank.

16. The electric vehicle charging system of claim 15, wherein:
the second electric power reference level is higher than the first electric power reference level; and
the controller is configured to:
store the electric power supplied to the electric power customer in the energy storage bank in a case in which a state in which a level of supplied electric power of the meter data is higher than the first electric power reference level is changed to a state in which the level of supplied electric power of the meter data is not higher than the first electric power reference level; and
control the electric vehicle charger to receive the energy stored in the energy storage bank in the state in which the electric vehicle charger charges the electric vehicle in a case in which the level of supplied electric power of the meter data is higher than the second electric power reference level.

17. The electric vehicle charging system of claim 16, wherein:
the first electric power reference level is 60% or more and 80% or less of the maximum level of electric power supplied to the electric power customer; and
the second electric power reference level is 70% or more and 90% or less of the maximum level of electric power supplied to the electric power customer.

18. The electric vehicle charging system of claim 12, wherein the electric vehicle charger comprises a plurality of electric vehicle chargers configured to charge a plurality of electric vehicles with the energy stored in the energy storage bank.

19. The electric vehicle charging system of claim 18, wherein:
the plurality of electric vehicle chargers comprises a plurality of coils for wireless electric power charging; and
the plurality of coils is arranged in a parking lot of the electric power customer.

20. The electric vehicle charging system of claim 12, wherein the electric power customer comprises an apartment complex.
